(19) United States
(12) Patent Application Publication
(10) Pub. No.: US 2007/0034324 A1
(43) Pub. Date: Feb. 15, 2007

(54) Fluorescent screen with metal back, and method of producing the same

(76) Inventors: Masayuki Yoshii, Saitama-ken (JP); Takeo Ito, Saitama-ken (JP); Hajime Tanaka, Gunma-ken (JP); Yasinori Gamo, Saitama-ken (JP); Masaki Inamura, Saitama-ken (JP); Tomoko Nakazawa, Gunma-ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/551,758

(22) PCT Filed: Mar. 31, 2004
(86) PCT No.: PCT/JP04/04697

§ 371 Date: Aug. 15, 2006

(30) Foreign Application Priority Data
Apr. 1, 2003 (JP) 2003-097853

(51) Int. Cl. B44C 1/17; B32B 37/12

(52) U.S. Cl. 156/233; 156/312; 156/239

(57) ABSTRACT

A method for forming a metal back-attached phosphor screen comprises forming a phosphor layer on an inner surface of a face plate, transferring a metal film, and heating and pressing the metal film transferred onto the phosphor layer by a press roller. The transferring includes disposing a transfer film having at least a base film, a metal film and an adhesive-agent layer on the phosphor layer so that the metal film contacts the phosphor layer via an adhesive agent, heating and pressing by a transfer roller to let the metal film adhere thereto, and peeling the base film Both the temperatures of the pressing sections of the transfer roller and press roller are 150 to 240° C. and both the pressing rates are 1.0 to 6.0 meter/minute. A metal back-attached phosphor screen exhibiting an excellent adhesiveness between the phosphor layer and a metal back layer and a superior withstand voltage characteristic can be formed with a good process yield.

### TECHNICAL FIELD

The present invention relates to a method for forming a metal back-attached phosphor screen, and particularly to a method for forming a metal back layer on a phosphor layer in a flat image display device such as a field emission display (FED) by a transfer method.

### BACKGROUND ART

Conventionally, in an image display device such as a cathode-ray tube (CRT) or a FED, a metal back-attached phosphor screen in which a metal film such as of Al is formed on an inner surface (the face opposite to a face plate) of a phosphor layer is largely adopted.

This metal back-attached phosphor screen aims to effectively transmit luminous energy to a front face of the face plate by reflecting a light emitted to the metal film (metal back layer) from the phosphor layer excited by electrons from an electron source, and to let the phosphor layer serve as an electrode by giving conductivity to the phosphor layer.

The formation of the metal back layer is conventionally performed by methods such as a lacquer method in which a thin film made of nitrocellulose or the like is formed on the phosphor layer by a spin method or the like, Al is deposited thereon, and organic matters are removed by baking.

Further, as a convenient formation method of the metal back layer, there is proposed a method (transfer method) in which a metal film is formed by a deposition on a film having a release agent previously coated thereon, and is transferred onto the phosphor layer with an adhesive agent. (Refer to Japanese Patent Laid-open Application No. Sho 63-102139.)

However, in the conventional metal back layer formation method on the basis of the transfer, it is difficult to ensure enough adhesiveness between the phosphor layer and the metal back layer and realize a favorable withstand voltage characteristic.

Specifically, in general, in the film transfer using a transfer roller,the thickness of a film to be transferred,the surface temperature of the transfer roller and the transfer rate are closely connected, and thereby the surface temperature of the transfer roller and the transfer rate are prescribed in accordance with the thickness of the transfer film and/or the softening temperature of the adhesive agent. In the metal back layer formation based on the transfer method, there is a problem that the setting ranges of the above-described respective conditions are small, and thereby a larger fluctuation is caused in the adhesiveness between the phosphor layer and the metal back layer, so that the withstand voltage characteristic fells to cause a transfer failure or a blistering failure, ending in a lower product yield.

The present invention has been made to bring a solution to the above problem, and an object thereof is to provide a method for forming a metal back-attached phosphor screen exhibiting a favorable adhesiveness between a phosphor layer and a metal layer as well as a superior withstand voltage characteristic with a good process yield.

### DISCLOSURE OF THE INVENTION

A method for forming a metal back-attached phosphor screen according to the present invention comprises forming a phosphor layer on an inner surface of a face plate, transferring a metal film, the transferring including disposing a transfer film having at least a base film, a metal film and an adhesive-agent layer formed on the base film so as to have the metal film come into contact with the phosphor layer through an adhesive-agent layer, heating and pressing by a transfer roller to adhere the transfer film onto the phosphor layer and then stripping the base film therefrom, and heating and pressing the metal film by a press roller, the metal film being transferred onto the phosphor layer, in which in the transferring, a temperature of a pressing section of the transfer roller is 150 to 240° C. and a pressing rate thereof is 1.0 to 6.0 meter/minute, and in the heating and pressing, a temperature of a pressing section of the press roller is 150 to 240° C. and a pressing rate thereof is 1.0 to 6.0 meter/minute.

In this method for forming the metal back-attached phosphor screen, the thickness of the base film of the transfer film may be 5 to 30 μm, the pressing force of the transfer roller may be 300 to 800 kgf/cm², and the pressing force of the press roller may be 500 to 1000 kgf/cm².

Further, in the present invention, at least one of the transfer roller or the press roller may be the roller having a circumference of a length being equal to the length along a pressing direction of an area to be pressed in the transfer film or longer than it may be used. Moreover, both the transfer roller and press roller may have the circumference of the length being equal to the length along the pressing direction of the area to be pressed in the transfer film or longer than it.

Furthermore, for at least one of the transfer roller or the press roller, a rubber roller having a covering layer of a thickness of 5 to 30 mm and made of a rubber having a hardness of 70 to 100 degrees on a metal core may be used. Moreover, both of the transfer roller and the press roller may be a rubber roller respectively having a covering layer of a thickness of 5 to 30 mm and made of a rubber having a hardness of 70 to 100 degrees on the metal core.

### BRIEF DESCRIPTION OF DRAWINGS

FIGS. 1A and 1B are views schematically showing a transfer step by a transfer roller in the embodiment of the present invention, in which FIG. 1A is a plan view and FIG. 1B is a front view.

FIG. 2 is a sectional view of a FED provided with a metal back-attached phosphor screen formed by the embodiment according to the present invention.

### BEST MODE FOR IMPLEMENTING THE INVENTION

Hereinafter, embodiments of the present invention will be described. It should be noted that the present invention is not limited to the embodiments described below.

In the embodiment according to the present invention, first, a light absorption layer (light-shielding layer) made of a black pigment and having, for example, a striped shape is formed on an inner surface of a face plate by a photolithography technology; a slurry containing phosphor materials of respective colors such as a ZnS group, a Y₂O₃ group, and a Y₂O₂S group is coated thereon and is dried; and a patterning is performed with the photolithography technology. In this way, a phosphor screen having striped phosphor layers of three colors of red(R), green (G) and blue (B) arranged side by side between the patterns of the light absorption layer is formed. The phosphor layers of respective colors can be formed by a spray method or by print processes.

Subsequently, a metal film such as of Al is transferred onto the phosphor screen by a transfer method which will be described below.

A transfer film has a multilayered structure in which a release agent layer, the metal film such as of Al and an adhesive agent layer are formed sequentially on a base film made of a polyester resin or so forth. Here, the film thickness of the base film is preferably 5 to 30 μm so as to effectively perform heating and pressing by a transfer roller in a later-described transfer process.

As a release agent, there are a cellulose acetate, wax, fatty acid, fatty-acid amide, fatty ester, rosin, acrylic resin, silicone, fluorocarbon resin and so forth, and out of these, some one is selected appropriately in accordance with the removability from the base film and a later-described protective film and so on to be used. Further, as an adhesive agent, a vinyl acetate resin, ethylene vinyl acetate copolymer, stylen acrylate resin, ethylene-vinyl acetate-acrylic acid terpolymer resin or the like is used. Furthermore, between the release agent and the metal film, a protective film composed of a thermosetting resin, a thermoplastic resin, a light-curing resin or the like as a base and containing a softening agent may be provided.

Next, the transfer film of such a structure is disposed so that the adhesive agent layer thereof being in contact with the phosphor layer, and is heated and pressed by the transfer roller. After the metal film adheres thereto, the base film is stripped.

As a transfer roller, a rubber roller having a covering layer made of a natural rubber or a silicone rubber on a metal core made of iron or the like is used. The rubber covering layer preferably has a hardness of 70 to 100 degrees and a thickness of 5 to 30 mm. The transfer roller is heated to the extent that the rubber layer surface being a pressing section has a temperature of 150 to 240° C., and is moved over the surface of the base film of the transfer film at a rate of 1.0 to 6.0 meter/minute while pressing so that the metal film adheres. Incidentally, the pressing force is preferably 300 to 800 kgf/cm² (for example, 300 kgf/cm²).

The previously-described ranges of the surface temperature and pressing rate of the transfer roller are necessary and sufficient conditions for the transfer film to be contacted and pressed by the transfer roller while the film is in the sufficiently heated state in the transfer process, and out of these ranges, the adhesiveness between the phosphor layer and the metal film becomes insufficient and a transfer failure or a crack after the baking is possibly caused in the metal film.

Specifically, when the transfer roller has an excessively high surface temperature or an excessively slow pressing rate, the base film is excessively heated to be softened and melted to cause a crack at the corresponding part of the metal film after the baking, being unfavorable. When the transfer roller has an excessively low surface temperature or an excessively high pressing rate, the adhesive agent is not sufficiently heated and a transfer failure partly failing to transfer the metal film is caused, lowering the product yield.

Note that, in the pressing by the transfer roller, it is possible to adopt a mode in which the face plate being a pressed section is fixed to move the transfer roller, whereas it is also possible to adopt a mode in which the position of the transfer roller is fixed to run or move the face plate side. The pressing rate of the transfer roller means a relative movement speed between the transfer roller and the pressed section.

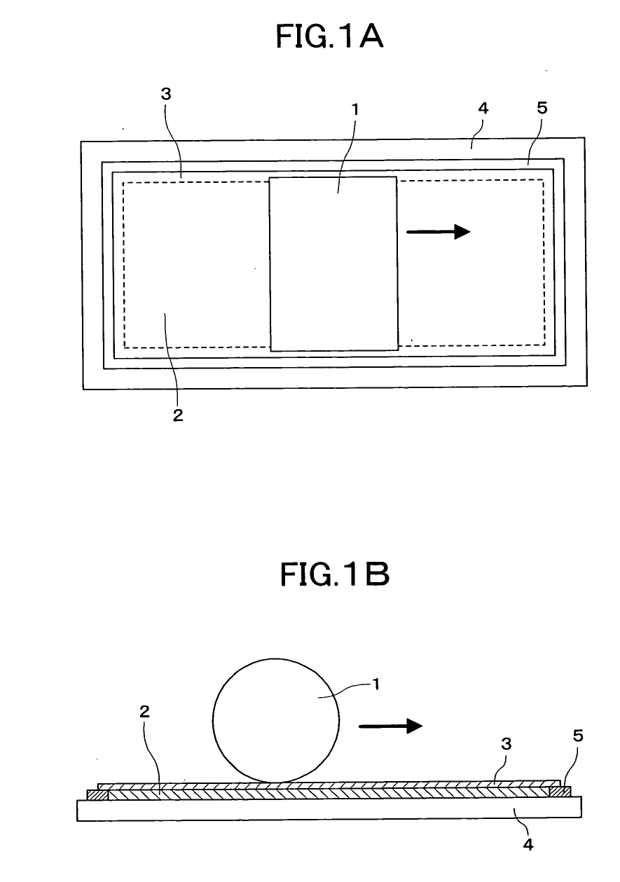

Further, as shown in FIGS. 1A and 1B, as a transfer roller 1, a cylindrical rubber roller with a large diameter is used. The length of the circumference of this rubber roller is preferably equal to the length in the longitudinal direction (a direction to be pressed in chronological order as shown by an arrow) of the area to be pressed of a transfer film 3 arranged in a phosphor screen 2 or longer than it. Also, the length in the axial direction of the transfer roller 1 is preferably equal to the length of the lateral direction (the direction orthogonal to the direction to be pressed) of the area to be pressed of the transfer film 3 or longer than it. In FIGS. 1A and 1B, a numerical reference 4 denotes a face plate and a numerical reference 5 denotes a peripheral light-shielding layer formed at a peripheral section of the face plate 4. The peripheral light-shielding layer 5 is electrically connected with (conducted to) a metal back layer.

The temperature of the pressing section being the surface of the transfer roller 1 downs by 30 to 50° C. due to the contact with the transfer film 3. The transfer roller 1 is then continuously heated while moving through under a roller heating section (heater) provided thereabove and the surface temperature increases again, however, the temperature increases at most up to that 20 to 30° C. lower than the temperature before contacting the roller heating section (heater).

Thus, the continuous heating cannot provide enough heating time and thereby proves a difficult task to increase the surface temperature of the transfer roller 1 up to a desired temperature. Additionally, the surface temperature of the pressing section of the transfer roller 1, which has once downed in use for the transfer, cannot be increased to the desired temperature by the time when the transfer roller 1 makes a round and backs to contact with the pressed section again, so that a transfer failure is readily caused in the second round and thereafter backed because the adhesive agent is insufficiently by the contact of the transfer roller 1.

Accordingly, the length of the circumference of the transfer roller 1 is preferably equal to the length in the pressing direction of the area to be pressed or longer than it so that the entire area to be pressed can be heated and pressed in a single round of the roller after the entire surface of the transfer roller 1 is heated to the desired temperature based on a batch processing.

After the metal film is transferred onto the phosphor face (phosphor screen) of the face plate, the transferred metal film is heated and pressed by the press roller.

As a press roller, as in the case of the previously-described transfer roller, a rubber roller having a covering layer made of a natural rubber or silicone rubber around a metal core such as of iron can be used. The rubber covering layer preferably has a hardness of 70 to 100 degrees and a thickness of 5 to 30 mm. This press roller is heated so that the rubber layer face being the pressing section has a temperature of 150 to 240° C., and is then moved on the metal film at a pressing rate of 1.0 to 6.0 meter/minute, to closely contact the metal film with the phosphor screen. The pressing force is preferably 500 to 1000 kgf/cm².

The previously-described ranges of the surface temperature and pressing rate of the press roller are necessary and sufficient conditions for the metal film to be pressed in the sufficiently heated state by being contacted by the press roller, and out of these ranges, the adhesiveness between the phosphor layer and the metal film becomes insufficient and a down in demarcation holding voltage or a blistering in the metal film is possibly caused.

Specifically, when the press roller has an excessively low surface temperature or an excessively high pressing rate, the adhesiveness between the metal film and the phosphor layer becomes insufficient, being unfavorable. When the press roller has an excessively high surface temperature or an excessively low pressing rate, the adhesiveness is improved further but the organic matter removal through the baking is prevented, being unfavorable. That is, the organic matter remained after the removal is carbonized, and the carbonized organic matter becomes a brown stain when viewing the face plate from the outer side thereof (from the opposite side of the inner surface on which the metal film is transferred). The stain prevents an efficient transmission of the luminous energy to the front face of the face plate, damaging the function as an image display device, being unfavorable.

Further, as a press roller, as in the case of the transfer roller, preferably, a cylindrical rubber roller having a large circumference being equal to the length in the pressing direction of the area to be pressed of the metal film transferred onto the phosphor face or longer than it is used. Further, the length in the axial direction of the press roller is preferably equal to the length of in the direction orthogonal to the pressing direction of the area to be pressed or longer than it.

As in the case of the transfer roller, the surface temperature of the pressing section of the face of the press roller downs by 30 to 50° C. when contacting the metal film transferred onto the phosphor screen of the face plate. The surface temperature of the press roller is increased again by passing through the roller heating section provided thereabove by which the passing portion is continuously heated however, the temperature increases at most up to that 20 to 30° C. lower than the temperature before contacting the roller heating section (heater).

Thus, the continuous heating cannot provide enough heating time and thereby proves a difficult task to increase the surface temperature of the press roller to a desired temperature. Since the surface temperature of the press roller, which has once downed by being used in the transfer, cannot increase to the desired temperature by the time when the press roller makes a round and backs to contact with the pressed section again, the improvement of the adhesiveness backed by the heating and pressing becomes insufficient in the second round and thereafter. As a result, the demarcation holding voltage lowers, causing deterioration in a withstand voltage characteristic.

Accordingly, the length of the circumference of the press roller is preferably equal to the length in the pressing direction of the area to be pressed or longer than it so that the entire area to be pressed can be heated and pressed in a single round after the entire surface of the press roller is heated to the desired temperature based on a batch processing.

Note that, in the pressing by the press roller, it is possible to adopt a mode in which the face plate being the pressed section is fixed and the press roller is moved, and it is also possible to adopt a mode in which the position of the press roller is fixed and the face plate side is moved or run. The pressing rate of the press roller means a relative movement speed between the press roller and the pressed section.

Thus, after pressing the metal film, the entire face plate is heated at a temperature of approximately 450° C. to be baked so that the organic matter is decomposed or removed r therefrom. In this manner, a metal back-attached phosphor screen exhibiting a superior adhesiveness between the phosphor layer and the metal back layer can be obtained.

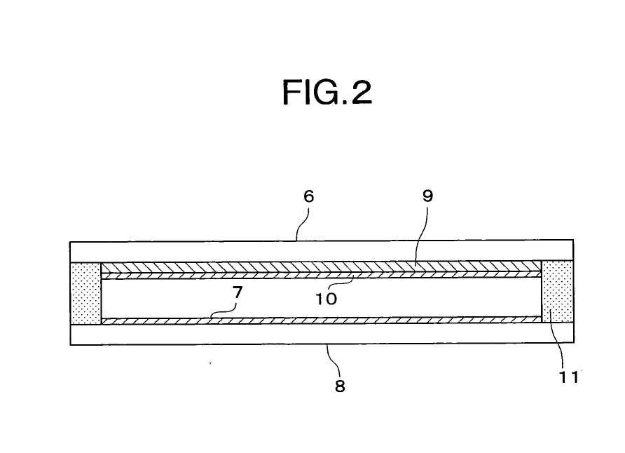

Next, the description will be given of a FED having the thus-formed metal back-attached phosphor screen as an anode electrode based on FIG. 2.

In the FED, a face plate 6 having the metal back-attached phosphor screen formed in the above-described mode and a rear plate 8 having electron-emitting elements aligned in a matrix shape therein are arranged to confront with each other by having a narrow space of approximately 1 mm to several mm therebetween, in which a high voltage ranging from 5 to 15 kV is applied between the face plate 6 and rear plate 8. A numerical reference 9 in the drawing denotes a phosphor screen having a striped light absorption layer and phosphor layer, and a numerical reference 10 denotes a metal back layer. Also, a numerical reference 11 denotes a support frame (side wall).

The space between the face plate 6 and the rear plate 8 is extremely narrow, so that a discharge (dielectric discharge) tends to be caused therebetween, however, the FED has a smooth and flat metal back layer 10 without any convex, concave, crackling, corrugation or the like and exhibiting a higher adhesiveness between the metal back layer 10 and the phosphor screen 9, so that the electrical discharge is prevented and the withstand voltage characteristic is substantially improved. On top of that, it is possible to realize a display with a high level of luminance, purity of color and reliability.

Subsequently, a specific example applying the present invention to a FED will be described.

### EXAMPLE

After a striped light absorption layer (light-shielding layer) composed of a black pigment was formed on an inner surface of a face plate by a photolithography technology, a slurry containing phosphor materials of respective colors such as a ZnS group, a Y₂O₃ group, and a Y₂O₂S group was coated thereon and was dried and a patterning was performed using the photolithography technology. In this way, a phosphor screen was produced by forming phosphor layers of three colors of red (R), green (G) and blue (B) to be arranged side by side in a striped manner between the light-shielding sections.

Next, a transfer film described below was produced. Specifically, a releasing agent layer having a thickness of 0.5 μm was formed on a base film made of polyester having a film thickness of 20 μm; an Al film having a thickness of 50 nm was formed thereon by depositing Al; and a composition of resin composed of 90 parts of toluene and 10 parts of vinyl acetate was coated on the Al film by a gravure coater and dried, so that an adhesive agent layer was formed.

Next, the transfer film was disposed so that the adhesive agent layer was in contact with the phosphor layer, then the transfer film was pressed by a rubber roller (transfer roller) of a hardness of 90 degrees with a surface temperature of 200° C. at a pressing rate of 5.4 meter/minute and a pressure of 500 kgf/cm² to adhere, and the base film was stripped thereafter. The Al film was transferred onto the phosphor screen of the face plate.

Next, with the use of a rubber roller (press roller) of a hardness of 80 degrees with a surface temperature of 180° C., the Al film was pressed at a pressing rate of 1.0 meter/minute and a pressure of 800 kgf/cm², to thereby closely attached onto the phosphor screen. Thus, the face plate with its Al film finishing the press operation was heated and baked at a temperature of 450° C. to remove or decompose the organic matter.

In the above-described steps, the Al film was transferred onto the phosphor screen, and with the further press operation, a metal back layer with out problems such as a transfer failure, cracking or blistering could be formed, so that the process yield was improved.

Subsequently, with the use of the face plate with the metal back-attached phosphor screen formed in the above-described manner, a FED was fabricated by a general method. First, a rear plate was fabricated by fixing an electron generating source having a large number of electron-emitting elements of a surface conductive type formed in a matrix shape thereon to a glass electrode. Next, the rear plate and the face plate were arranged to confront with each other via a support frame and spacer to be attached with frit glasses. After that, required operations such as sealing and exhaust were performed to complete a 10-inch color FED.

When a 1000-hours running test at an electron-beam acceleration voltage of 5 kV was conducted with respect to this FED, no electric discharge could be seen as a phenomenon.

### INDUSTRIAL APPLICABILITY

As has been described in the above, according to the present invention, the transferability and baking-resistant characteristic of the metal film are improved, and as a result, the adhesiveness between the phosphor layer and the metal back layer is increased to improve a demarcation holding voltage. Accordingly, the metal back-attached phosphor screen of the image display device with an excellent withstand voltage characteristic can be produced with a favorable process yield.

1. A method for forming a metal back-attached phosphor screen comprising:
forming a phosphor layer on an inner surface of a face plate;
transferring a metal film, the transferring including disposing a transfer film having at least a base film, a metal film and an adhesive-agent layer formed on the base film so as to have the metal film come into contact with the phosphor layer through an adhesive-agent layer, heating and pressing by a transfer roller to adhere the transfer film onto the phosphor layer and then stripping the base film therefrom; and
heating and pressing the metal film by a press roller, the metal film being transferred onto the phosphor layer,
wherein, in the transferring, a temperature of a pressing section of the transfer roller is 150 to 240° C. and a pressing rate thereof is 1.0 to 6.0 meter/minute, and in the heating and pressing, a temperature of a pressing section of the press roller is 150 to 240° C. and a pressing rate thereof is 1.0 to 6.0 meter/minute.

2. The method for forming the metal back-attached phosphor screen as set forth in claim 1, wherein a thickness of the base film of the transfer film is 5 to 30 μm.

3. The method for forming the metal back-attached phosphor screen as set forth in claim 1, wherein the pressing force of the transfer roller is 300 to 800 kgf/cm², and the pressing force of the press roller is 500 to 1000 kgf/cm².

4. The method for forming the metal back-attached phosphor screen as set forth in claim 1, wherein at least one of the transfer roller or the press roller has a circumference of a length being equal to the length along a pressing direction of an area to be pressed in the transfer film or longer than it.

5. The method for forming the metal back-attached phosphor screen as set forth in claim 4, wherein both the transfer roller and press roller have the circumference of the length being equal to the length along the pressing direction of the area to be pressed in the transfer film or longer than it.

6. The method for forming the metal back-attached phosphor screen as set forth in claim 3, wherein at least one of the transfer roller or the press roller is a rubber roller having a covering layer of a thickness of 5 to 30 mm and made of a rubber having a hardness of 70 to 100 degrees on a metal core.

7. The method for forming the metal back-attached phosphor screen as set forth in claim 6, wherein both of the transfer roller and the press roller are a rubber roller respectively having a covering layer of a thickness of 5 to 30 mm and made of a rubber having a hardness of 70 to 100 degrees on the metal core.

8. The method for forming the metal back-attached phosphor screen as set forth in claim 2, wherein the pressing force of the transfer roller is 300 to 800 kgf/cm², and the pressing force of the press roller is 500 to 1000 kgf/cm².
